(19) United States
(12) Patent Application Publication
(10) Pub. No.: US 2009/0099926 A1
(43) Pub. Date: Apr. 16, 2009

(54) Methods Of Improving Long Term Business Arrangements

(75) Inventor: Hollis Bascom, Union City, CA (US)

Correspondence Address: MEDLEN & CARROLL, LLP, Suite 350, 101 Howard Street, San Francisco, CA, 94105, US

(73) Assignee: Orcon Corporation

(21) Appl. No.: 12/247,724

(22) Filed: Oct. 8, 2008

Related U.S. Application Data
(60) Provisional application No. 60/998,512, filed on Oct. 10, 2007.

(51) Int. Cl. G06Q 30/00

(52) U.S. Cl. 705/14; 705/400

(57) ABSTRACT

The invention relates to a method of improving long-term business arrangements, preferably by enabling supplier(s) and purchaser(s) to share reductions in supplier's costs of production and/or purchaser's costs of using or selling the product. In some embodiments, the invention relates to a method of pricing a transaction wherein a product is supplied to a purchaser in multiple transactions, each transaction being priced on the basis of (1) the production cost of the product supplied in the transaction, and (2) a profit for the supplier wherein, as the costs of production decline in successive transactions, the supplier's profit is adjusted such that both the supplier and the purchaser benefit by sharing a portion of the reduction in production costs. In other embodiments, the supplier and the purchaser share a portion of a reduction in the cost of purchaser's use of the product.

### FIELD OF INVENTION

The invention relates to a method of improving long-term business arrangements, preferably by enabling supplier(s) and purchaser(s) to share reductions in supplier's costs of production and/or purchaser's costs of using or selling the supplied product. In some embodiments, the invention relates to a method of pricing a transaction in a plurality of transactions between a supplier and a purchaser, each transaction being priced at an amount equal to (1) the production cost of the product supplied in the transaction, and (2) a profit for the supplier wherein, as the costs of production decline in successive transactions, the price or the supplier's profit, or both, are adjusted such that both the supplier and the purchaser benefit by sharing a portion of the reduction in production costs. In other embodiments, the supplier and the purchaser share a portion of a reduction in the cost of purchaser's use of the product.

### BACKGROUND

Long-term supply contracts with fixed prices, or with fixed schedules of price reductions, are utilized extensively in modern business, especially to manage supply chains. Purchasers benefit from such contracts because they can budget for future costs, and suppliers benefit because of a reliable source of business, among other reasons. However, a supply contract continues to benefit all parties only to the extent its terms can accommodate future economic events. In many traditional original equipment manufacture (“OEM”) supply contracts, the supplier agrees to lower the transaction price from transaction to transaction according to a predetermined schedule. Implicit in the promise is supplier's assumption that supplier's costs will decline in successive transactions. However, future events may make continued execution of such an agreement unprofitable, causing the parties to terminate or renegotiate the terms of the agreement, both of which generate considerable expense by adding transactional costs to the arrangement. Thus, there is a need for business methods that intrinsically accommodate future events, thereby allowing mutually beneficial relationships to sustain themselves.

### SUMMARY OF INVENTION

The invention relates to a method of improving long-term business arrangements, preferably by enabling supplier(s) and purchaser(s) to share reductions in supplier's costs of production and/or purchaser's costs of using or selling the product. In some embodiments, the invention relates to a method of pricing a product supplied in each transaction in a plurality of transactions, wherein a supplier provides a product to a purchaser. Each transaction is priced on the basis of (1) the production cost of the product supplied in the transaction, and (2) a profit for the supplier, wherein, as the costs of production decline in successive transactions, the supplier's profit is adjusted such that both the supplier and the purchaser benefit by sharing a portion of the reduction in production costs. The first transaction engaged in has a price consisting of the production costs of the product supplied plus an amount to profit the supplier. A second transaction engaged in is defined upon the first occurrence of a transaction having a lower production cost than the first. The cost reduction is used to determine the price of the second transaction: The second price consists of the second cost of production plus a portion of the cost reduction amount, plus an amount to profit the supplier (the “second profit amount”). The prices and the profits of the transactions may be stated, respectively, as price per unit and profit per unit of product supplied. In preferred embodiments, the second price is less than the first price. In some embodiments, the portion of the cost reduction added back to production cost is an amount less than all of the cost reduction. In some embodiments, the second profit amount is not more than the first profit amount. In a preferred embodiment, profit as a percentage of price remains constant from transaction to transaction. That is, the first profit amount, expressed as a fraction of the first price, equals the second profit amount, expressed as a fraction of the second price.

In other embodiments, the costs associated with purchaser's use of supplier's product are recorded and/or monitored. As the costs of such use decline, the purchaser's profit is adjusted such that both the supplier and the purchaser benefit by sharing a portion of the reduction in purchaser's costs of using the product. A cost of use may be identified with respect to each unit of product used, or with respect to all product used to complete a project.

In some embodiments, the invention relates to a method of sharing (or apportioning), between a supplier and a purchaser, a reduction in production costs comprising: a) supplying a product to said purchaser in a plurality of transactions at a plurality of transaction prices to be paid to said supplier by said purchaser for said product, wherein a first transaction price comprises: i) a first cost of production and ii) a first profit for the supplier; b) supplying said product to said purchaser in a second transaction subsequent to said first transaction at a second transaction price, said second price comprising a cost of production of said product for said second transaction, wherein said second cost of production is less than said first cost of production, thus providing a cost reduction; c) calculating a second transaction price by adding together said second cost of production and a second profit, plus a portion of said cost reduction, thus apportioning a first and a second portion of said cost reduction between said supplier and said purchaser such that said first portion of said cost reduction reduces the said second price. In further embodiments, said portion is determined so as to provide said supplier with a second profit, as a percentage of said second price, equal to said first profit as a percentage of said first price. In further embodiments, said portion is determined so as to provide said supplier with a second profit, as a percentage of said second price, greater than said first profit as a percentage of said first price. In further embodiments, said second transaction occurs a month or more after said first transaction. In one embodiment said supplier and said purchaser are separately owned or controlled. In one embodiment said supplier and said purchaser are commonly owned or controlled and said supplier and said purchaser make transactions as separate profit centers under a system of transfer pricing within a single firm.

In other embodiments, the invention relates to a method of sharing (or apportioning), between a supplier and a purchaser, a reduction in said purchaser's costs of using said supplier's product comprising: a) use by said purchaser, in each of a plurality of projects, of at least one unit of said product, wherein a first of said projects has a first product-unit cost of using said product and a second of said projects has a second product-unit cost of using said product, wherein said second cost is less than said first cost, thus providing a use-cost reduction, and b) apportioning said use-cost reduction between said supplier and said purchaser.

In some embodiments, the invention relates to a method of sharing (or apportioning), between a supplier and a purchaser, a reduction in production costs comprising: a) supplying at least one unit of a product (“product-unit”) to said purchaser in each of a plurality of transactions at a price per product-unit, including a first price in a first transaction, said price comprising: i) a cost of production, and ii) a profit for the supplier; b) supplying said product to said purchaser in a subsequent transaction at a second price per product-unit, said second price comprising a second cost of production for said product for said second transaction, wherein said second cost of production is less than said first cost of production, thus providing a production cost reduction; and c) calculating a second transaction price by adding together said second cost of production and a second profit amount, plus a portion of said cost reduction, thus apportioning a first and a second portion of said cost reduction between said supplier and said purchaser such that said first portion of said cost reduction reduces the said second price. In further embodiments, said portion is determined so as to provide said supplier with a second profit, as a percentage of said second price, equal to said first profit as a percentage of said first price. In further embodiments, said portion is determined so as to provide said supplier with a second profit, as a percentage of said second price, greater than said first profit as a percentage of said first price.

In one embodiment, the supplier supplies the product to the purchaser in a plurality of transactions, which plurality includes an ordered set of transactions beginning with a first transaction having a first production cost, followed by transactions having production costs that decline (relative to the production cost for the first transaction) monotonically over time. A price is determined for the first transaction of the plurality of transactions, which price includes the supplier's cost of producing the product, and a first profit for the supplier. To determine a price for a next defined transaction, an inter-transaction production cost reduction (the production cost reduction that occurred between the first transaction and the transaction next defined in the ordered set) is first found. A price for the next defined transaction is then found by adding together the cost of producing the product supplied by the supplier in that transaction and a second profit, plus a portion of the inter-transaction production cost reduction.

In one embodiment, the portion of the inter-transaction production cost reduction is set at zero. In preferred embodiments, the portion is set at a positive value. In one embodiment, the positive value is set to provide a profit greater than the first profit. In one embodiment, the positive value is set such that the supplier's profit as a percentage of purchaser's price remains constant. In one embodiment, the positive value is set such that the supplier's profit as a percentage of purchaser's price increases.

In some embodiments, the invention relates to a method of sharing, between a supplier and a purchaser, a reduction in a purchaser's costs of using the supplier's product, wherein said costs comprise a product purchase price exacted by the supplier and, separately, a project cost. In one embodiment, the supplier supplies, and the purchaser uses, the product in a plurality of projects, which plurality includes an ordered set of projects beginning with a first project having a first project cost, followed by projects having project costs that decline (relative to the project cost of the first project) monotonically over time. For a next project defined in the ordered set, an inter-project reduction in project cost (the project cost reduction that occurred between the first project and the project next defined in the ordered set) is determined. A portion of the project cost reduction is payable to the supplier.

### DETAILED DESCRIPTION

In order to deliver sustained best value to users, each segment of a supply chain (e.g., raw material suppliers, fabricators, customers, users, and end-users or consumers) should be proficient in “lean” activities within its several functions (e.g., purchasing, quality control, engineering, order entry, accounting, manufacturing, collections, sales, contracting, training, selling, banking, administration, recruiting, shipping, receiving, financing, auditing, marketing, financing, payroll, employee relations, inventory control, etc.).

While many organizations are committed in various degrees to continuous improvement in productivity and quality, the reward for each preceding segment in the supply chain is not assured. One problem is that not every segment of a supply chain has a sufficient reward process for continuous improvement. In some situations, for example, purchasers want a commitment from fabricators to cut prices at a fixed amount each year for three to five years. This does not promote the cooperative effort needed to necessarily cut costs. If incentives are not appropriate, suppliers may be driven out of business by unrealistic expectations. Thus, there is a need for methods that promote a collaborative team process that rewards both team members as long as both members are fully engaged and follow the agreed upon formula. Parties can reap optimum sustained results over time.

As used herein, the term “product” refers to any good or service offered for sale, and includes any set (or “bundle”) of attributes that confer upon a purchaser a benefit or a perception thereof, regardless of the inputs applied to the product by the supplier. Thus, the term encompasses all economic outputs, whether commodities, deliverables, work-product, or otherwise, both tangible and intangible.

As used herein, the term “production” refers to any business activity or set of activities directed at the goal of creating a product (as “product” is defined herein). The term is not limited to the activities of a supplier. A purchaser making use of a purchased product for a business purpose is also engaged in “production.”

As used herein, the term “production cost” refers, in preferred embodiments, to a fully burdened cost because a firm's management of every factor of production is subject to the discipline of maximizing output for a given input (“productivity”) without compromising quality. The embodiments of the invention, however, encompass any other measure of cost that may be applied to evaluate a transaction, including, without limitation, marginal cost, standard cost, full cost, average cost, direct cost, indirect cost, variable cost, fixed cost, and combinations thereof. The foregoing terms will be understood by persons of ordinary skill in the art of management accounting, but any calculation for arriving at a cost, as agreed upon by the parties to the transaction, is within the scope of the various embodiments of the invention.

As used herein, the term “use-cost” (or “cost of use” or “cost of using”), in preferred embodiments, excludes the price (as that term is defined herein) of the product used, insofar as that price is determined according to an embodiment of the invention, but is otherwise a fully burdened cost that includes, where applicable, selling costs.

The term “lean” or “lean management” refers to the discipline of maximizing the productivity of all factors of production, at a given level of quality.

As used herein, the term “supplier” refers to any provider or vendor of a product, including, without limitation, an extractor, refiner, manufacturer, assembler, or re-seller, who equips a purchaser or otherwise furnishes a purchaser with a product, or promises to do so. By way of example and not of limitation, a supplier may function as a wholesaler, retailer, distributor, original equipment manufacturer, or service provider.

As used herein, the term “transaction” refers to an agreement between a supplier and a purchaser to exchange, as a unit of business activity, an asset (for example, a product) and a payment in consideration of the exchange (for example, cash). The term also refers to any act of performing (e.g., “supplying” and “purchasing”) under such an agreement. In some contexts, the term may further refer to a record of the exchange. Where the asset is a product, the asset may comprise several essentially interchangeable units, referred to herein as a “unit-product” or a “product-unit.” A product-unit may be an atomic unit (i.e., divisible only by compromising or destroying the benefit the product confers upon the purchaser) or a measured quantity of such atomic units (e.g., a “barrel,” a “bushel,” etc.).

As used herein, “price” (or “transaction price”) refers to a payment made or promised for the transaction, which payment consists of: (1) the costs of producing the product transferred in the transaction, (2) a profit amount, and (3) where applicable, a portion of a reduction in production cost. The “price per product-unit” as used herein refers to the transaction price divided by the number of units of product exchanged in the transaction. It is to be understood that other payments besides “price,” as that term is used herein, may be associated with a transaction without changing the “price” of the transaction. That is, as used herein, “price” is but an element of the consideration paid or payable in a transaction.

As used herein, the term “purchaser” refers to any party to a transaction, which party pays or promises to pay the transaction price.

As used herein, the term “project” refers to an activity or a set of activities in which a purchaser uses a product purchased from a supplier. At least one of the activities is substantially the same project-to-project and the costs of conducting the activity are recorded project-by-project. A “reduction” in the cost(s) of using a product in a project refers generally to any increase in the economic value of the project to a purchaser of the product, such as the project's owner or a contractor undertaking the project. Generally, herein, the terms “project cost(s)” and “reduction in project cost(s)” are used to refer to project costs exclusive of the price of the product supplied by the supplier to the purchaser (as the term “price” is defined herein).

The terms “pay,” “paid” and “payment” refer to any payment the purchaser makes or promises to make. The terms are not limited by the medium of exchange in which a payment is denominated or the time(s) or place(s) of such payment.

As used herein, the term “long-term supply contract” refers to a legally binding agreement between a supplier and a purchaser wherein the supplier promises to furnish the purchaser with an amount of a product in more than one delivery or transaction. The price of a product delivered thereunder may vary from transaction to transaction, generally according to a formula or rule set out in the contract.

As used herein, the term “ordered set” refers to a set of events (viz., “transactions” or “projects”) ordered according to the time each event occurred and according to a value for each event. To be admitted to the ordered set referred to herein, an event must either be the first to occur in time or must have a lesser value than that of the first event to occur in time. The order of the events admitted to the set is, first, the first event to occur in time; second, the event that occurs next in time, provided it also has a lesser value than the first; third, the event that next succeeds the second admitted event, provided it has a lesser value than second admitted event, etc. The values of the events in such an ordered set thus decline monotonically over time. The “values” referred to herein are production cost in the case of transactions, and project costs in the case of projects.

As used herein, a “production cost reduction” refers to any increase in the economic value of a unit of production to the producer (equivalent, in general, a decrease in the economic cost of a unit of production to the producer), and a “price reduction” encompasses any decrease in the economic cost to a purchaser. Thus, it is intended that the pricing methods described herein will apply (in an inflationary environment, for example) even if the practitioners were to encounter no absolute cost- or price reductions. That is, when any two or more “prices” are to be compared according to the embodiments of the inventions disclosed herein, it is intended that the comparison be made after adjusting for changes in the economic value of the currency or other medium of exchange (relative to a generally accepted standard such as the price of gold) in which costs and prices are denominated.

An “inter-transaction” production cost reduction refers herein to a decline in the cost of production between a given transaction in an ordered set of transactions (as “ordered set” is defined herein) and the immediately preceding transaction in the ordered set. The aforementioned “given transaction” is referred to herein as a “next transaction” or “second transaction.” Similarly, an “inter-project” cost reduction refers herein to a decline in a project cost between a given project in an ordered set of projects and the immediately preceding project in the ordered set. The aforementioned “given project” is referred to herein as a “next project” or “second project.”

As used herein, “profit” refers to any amount a supplier realizes from a transaction, which amount is not absorbed in supplier's recovery of production costs.

The embodiments of the inventions disclosed herein apply readily to a supplier and purchaser each independently owned or controlled. Many organizations, however, structure themselves to reflect the independence of supplier and purchaser by designating separate “profit centers,” “cost centers” and the like, wherein two centers conduct transactions structured as purchase and sale agreements to establish virtual prices, often referred to as “transfer prices.” It is contemplated that embodiments of the invention are applicable to such structures.

While the embodiments of the invention disclosed herein do not rely on any particular theory of their operability, it is widely accepted that, for sustained prosperity in an economy, it is preferred that all the firms comprising it continually improve their productivity. The principle applies also to supply chains. In some respects, supply chains behave like individual firms, especially inasmuch as not only products, but also information about the products and the money or credit to pay for them, flow through individual firms and through chains of firms alike. Indeed, although supply chains typically are networks of individual firms acting as suppliers and purchasers, they may comprise profit centers cooperating within a single firm under a system of transfer pricing.

It is generally accepted that firms and profit centers are motivated to improve productivity because it profits them to do so. It follows that a firm will be sensitive to the productivity of the chain in which it operates solely to the extent the chain's productivity directly affects the firm's income. A supplier's income may benefit when a long-term supply contract guarantees a schedule of increases in purchase volume. A purchaser's income may benefit from a supplier's productivity improvements when the contract includes a pre-negotiated schedule of price reductions. In such negotiations, however, the best alternative to a negotiated agreement may be to leave the supply chain. Such negotiations—and the agreements that result from them—do nothing to promote interest in a supply chain's productivity. Instead, such agreements tend to “squeeze” the profits of chain members, leading to early termination of contracts, and to the switching costs and other expenses that attend such termination. Thus, to encourage optimum and sustained results from a supply chain, there is a need for a method of distributing benefits to contracting parties in the chain; in particular, those benefits that flow directly from the parties' full and continuing engagement in the agreement.

Supply arrangements often contain terms that reduce the price paid for the product over time based on the assumption that the supplier will be able to reduce its costs of production. The arrangement will be beneficial for both the supplier and the purchaser only as long as the supplier can continue to reduce the cost of production. However, in most cases, the supplier comes to a point where the ability to reduce production costs will cease to correlate to the pricing arrangement.

Purchasers, for their part, can reduce their costs of using a supplied product as purchaser's experience with the product accumulates. Such cost reductions, however, tend to require the supplier's specific co-operation. Where competition does not promote such co-operation, an arrangement in which purchaser shares its savings (through cost reductions) with supplier may facilitate the needed co-operation.

Thus, it is an object of embodiments of the invention to reward lean business methods, and also save negotiating time and cost, as well as auditing time and cost. Another object is to promote teamwork of members of the supply chain in order to deliver on-time, high quality, top value products at affordable prices to customers, and save the cost of qualifying new suppliers.

In some embodiments, the invention relates to a method of addressing the above objectives by sharing reduced production costs when supplying a product to a purchaser in a plurality of transactions for a plurality of prices. At least two transactions, typically three or more, more typically four or more and in some cases ten or more, are governed according to the method. Each such transaction has a price, which price need not, but typically will, vary from transaction to transaction. Purchaser and supplier can negotiate a first price for a first transaction as a function of a first cost of production and a first profit for the supplier. Supplier can supply the product to purchaser in a second transaction at a second price. One can determine a second cost of production for the product for the second transaction, which is (or may be) less than the first cost of production. Such second cost, if less than the first, provides a production cost reduction. The reduction can be shared between supplier and purchaser by dividing the cost reduction into a first portion and a second portion. The price of the second transaction can be set lower than the price of the first (expressed preferably as a percentage) by choosing a value for the first portion of the cost reduction such that the chosen value, plus the (second) profit plus the (second) production cost is less than the price of the first transaction. At the same time, the profit for the second transaction, as a percentage of the second price, can be the same as the profit for the first transaction (as a percentage of the first price), or larger. That is, the second price provides the supplier with a second profit equal to or greater than the first profit at the second price as a function of the second cost reduction portion. It is to be understood that once the method has established the price of the second transaction, that price becomes the “first price” for purposes of calculating the price of a next (or “third”) transaction, and that third transaction becomes a “second transaction” for purposes of reading the disclosed method.

In further embodiments, the second transaction occurs a month or more after the first transaction. The interval between transactions is variable, e.g., one month, two months, three months, six months, twelve months or more) and may vary from transaction to transaction. In further embodiments, the agreement further stipulates that the first and second transactions occur within a predetermined period.

In some embodiments, the aforementioned methods of sharing reduced production costs when supplying a product to a purchaser in a plurality of transactions for a plurality of prices is governed by an agreement between supplier and purchaser.

In further embodiments, the agreement is a written agreement signed by the supplier. In further embodiments, the agreement is a written agreement signed by the purchaser. In further embodiments, the agreement is an oral agreement between the supplier and the purchaser.

In further embodiments, the agreement is unilateral or bilateral. In further embodiments, the agreement comprises three or more parties. In further embodiments, the three or more parties are members of a single organization.

In further embodiments, one of the parties is both a supplier and a purchaser in a supply chain.

In further embodiments, the agreement further stipulates that the second price is payable in an amount equal to the first price minus an amount that is a function of the first cost reduction variable. In further embodiments, the agreement further stipulates that the second price is payable as a first payment from the purchaser to the supplier as a function of the first price and a second payment from the supplier to the purchaser as a function of the first cost reduction variable. In further embodiments, the second payment is made later in time than the first payment.

In some embodiments, the invention relates to a method where a cost sharing agreement has a covenant of the supplier to supply a product to the purchaser in a plurality of transactions for a plurality of prices, beginning with a first price as a basis. The agreement also has a covenant of the purchaser to pay the supplier at the aforementioned prices and a first stipulation that, as the supplier achieves a cost reduction in producing the product for one of the plurality of transactions, the supplier shall, in the next succeeding transaction, supply the product to the purchaser at a second price equal to the basis less a portion of the cost reduction. The agreement also has a second stipulation that the second price replaces the first price as the basis. The purchaser pays the second price.

It is contemplated that the methods above will be particularly beneficial for improving lean management, but it is not intended that these embodiments be necessarily limited to having this effect. It is also specifically contemplated that this method can be extended to multiple, i.e., two, three or more, suppliers and purchasers in a supply chain.

A cardinal feature of modern supply chain management relates to the flow of product and financial information through the chain, usually enabled in software. Examples of such software include accounting and enterprise resource planning software that manages financials, order fulfillment, purchasing, inventory, time and billing, payroll, employee self-service, Web presence and customer lifecycle management that provides order management and project tracking. Persons of ordinary skill in the art will readily adopt such software for use in practicing the invention.

### EXAMPLES

The following examples are simple illustrations of the advantages, compared to the approach that is conventional in the prior art, of some embodiments of the invention.

### Example 1

A conventional supply contract is illustrated in Table 1. A given amount of product is to be supplied in each transaction under the assumption that production costs will decline 10% with each transaction and the reduction will pass through to the purchaser. In this case, supplier is actually able to achieve 10% reductions in production cost.

TABLE 1
Projected Production Cost Savings
(10% per Transaction) Passed to Purchaser

| | Dollars | % |
|---|---|---|
| 1^{st} Transaction | | |
| Production Cost | $85.00 | |
| Profit | $15.00 | 15% |
| Price | $100.00 | |
| 2^{nd} Transaction | | |
| Production Cost | $76.50 | |
| Cost Reduction | $8.50 | 10% |
| Profit | $15.00 | 16.4% |
| Price | $91.50 | |
| 3^{rd} Transaction | | |
| Production Cost | $68.85 | |
| Cost Reduction | $7.65 | 10% |
| Profit | $15.00 | 17.9% |
| Price | $83.85 | |

### Example 2

A conventional supply contract is illustrated in Table 2. A given amount of product is to be supplied in each transaction under the assumption that production costs will decline 10% with each transaction and the reduction will pass through to the purchaser. In this example, however, production costs actually decline only 5%, but the contractual obligation to pass through 10% remains in force.

TABLE 2
Projected Production Cost Savings (10% per Transaction)
Passed to Purchaser; Actual Cost Savings Are 5% per Transaction

| | Dollars | % |
|---|---|---|
| 1^{st} Transaction | | |
| Production Cost | $85.00 | |
| Profit | $15.00 | 15% |
| Price | $100.00 | |
| 2^{nd} Transaction | | |
| Production Cost | $80.75 | |
| Cost Reduction | $4.25 | 5% |
| Profit | $10.75 | 11.7% |
| Price | $91.50 | |
| 3^{rd} Transaction | | |
| Production Cost | $76.71 | |
| Cost Reduction | $4.04 | 5% |
| Profit | $7.14 | 8.5% |
| Price | $83.85 | |

### Example 3

Table 3 illustrates a supply chain where members agree on a fixed profit for supplier(s) as a percentage of the total price to customer(s). Other costs will fluctuate as the team of suppliers and purchasers focus on reducing costs as a team. The supplier and purchaser agree to share in the cost reductions as percentages (e.g., 50%-50%, 25%-75%, 75%-25%, etc.). As the costs go down, the purchaser receives a lower price, as a share of the cost reduction, while the percentage of the profit for the supplier does not decline.

TABLE 3
Profit to Supplier Fixed As a Percentage of Price to Purchaser

| | Dollars | % |
|---|---|---|
| 1^{st} Transaction | | |
| Production Cost | $85.00 | |
| Profit | $15.00 | 15% |
| Price | $100.00 | |
| 2^{nd} Transaction | | |
| Production Cost | $76.50 | |
| Cost Reduction | $8.50 | |
| Profit | $13.50 | 15% |
| Price | $90.00 | |
| 3^{rd} Transaction | | |
| Production Cost | $68.85 | |
| Cost Reduction | $7.65 | |
| Profit | $12.15 | 15% |
| Price | $81.00 | |

### Example 4

Table 4 illustrates an example of the method wherein shared savings are achieved even as profit increases in successive transactions. At a first point in time a customer pays $100.00 for a part. The part costs the supplier $85.00 to make; therefore, the supplier has a $15.00 profit for the transaction (15%). In the next transaction, the supplier is able to reduce the cost to make the product by 10%, a cost reduction of $8.50. Half of the cost reduction is $4.25. A new price of the product is the new production cost ($76.50) plus half of the cost reduction, $95.75. The new supplier profit ($95.75 minus the new production cost of $76.50) increases to $19.25, an increase to 20% from 15%. Half of the cost savings are shared with the purchaser. In the second transaction, an additional 10% cost reduction ($7.65) is achieved and half of the savings are again shared with the purchaser. Half of the cost reduction is $3.83. A new price of the product is the new cost of production plus half of the cost reduction, $91.93. The supplier has a new supplier cost of $68.85 and the new supplier profit increases to $23.08, an increase to 25% from the original 15%.

TABLE 4
Shared Savings, Profit Variable

| | Dollars | % |
|---|---|---|
| 1^{st} Transaction | | |
| Production Cost | $85.00 | |
| Profit | $15.00 | 15% |
| Price | $100.00 | |
| 2^{nd} Transaction | | |
| Production Cost | $76.50 | |
| Cost Reduction | $8.50 | 10% |
| ½ of Cost Reduction | $4.25 | |
| Profit | $19.25 | 20% |
| Price | $95.75 | |
| 3^{rd} Transaction | | |
| Production Cost | $68.85 | |
| Cost Reduction | $7.65 | 10% |
| ½ of Cost Reduction | $3.83 | |
| Profit | $23.08 | 25% |
| Price | $91.93 | |

I claim:

1. A method of pricing a product supplied in a plurality of transactions, comprising:
a. engaging in a first transaction in said plurality of transactions, said first transaction having (i) a first price, said first price consisting of a first cost of production, and (ii) a first profit amount;
b. engaging in a second transaction in said plurality of transactions, said second transaction having a second cost of production less than said first cost of production to provide a cost reduction amount, wherein said second transaction has a second price, said second price consisting of (i) said second cost of production plus a portion of said cost reduction amount, and (ii) a second profit amount.

2. The method of claim 1 wherein said first and second prices are prices per unit of said product and said first and second profit amounts are amounts per unit of said product.

3. The method of claim 1 wherein said portion of said cost reduction amount is less than all of said cost reduction amount.

4. The method of claim 1 wherein said second price is less than said first price.

5. The method of claim 1 wherein said second profit amount is not more than said first profit amount.

6. The method of claim 1 wherein said first profit amount as a fraction of said first price is a first fraction, said second profit amount as a fraction of said second price is a second fraction, and said first and second fractions are equal.

7. The method of claim 1 wherein said plurality of transactions comprises an ordered set of transactions beginning with said first transaction, followed by transactions having production costs that decline monotonically over time with respect to said first cost of production.

8. The method of claim 1, wherein said second transaction occurs a month or more after said first transaction.

9. The method of claim 1, wherein said supplier and said purchaser are members of a single organization.

10. The method of claim 9, wherein said members are profit centers.

11. A method of sharing, between a supplier and a purchaser, a reduction in production costs comprising:
a) supplying at least one unit of a product to said purchaser in each of a plurality of transactions, wherein each said transaction has a price per unit of said product, said price payable to said supplier by said purchaser, including a first transaction having a first price per unit payable to said purchaser by said supplier comprising:
i) a cost of production,
ii) a profit for the supplier;
b) supplying said at least one unit of product to said purchaser in a subsequent transaction at a second price per unit, said second price comprising a second cost of production for said product for said second transaction wherein said second cost of production is less than said first cost of production, providing a cost reduction, and
c) apportioning a first and a second portion of said cost reduction between said supplier and said purchaser such that said first portion of said cost reduction reduces said second price.

12. The method of claim 11, wherein said second transaction occurs a month or more after said first transaction.

13. The method of claim 11, wherein said supplier and said purchaser are members of a single organization.

14. The method of claim 13, wherein said members are profit centers.

15. A method of sharing, between a supplier and a purchaser, a reduction in said purchaser's costs of using said supplier's product comprising:
a) use by said purchaser, in each of a plurality of projects, of at least one product-unit of said product, wherein a first of said projects has a first product-unit cost of using said product and a second of said projects has a second product-unit cost of using said product, wherein said second cost is less than said first cost, providing a cost reduction, and
b) apportioning said cost reduction between said supplier and said purchaser.

16. The method of claim 15, wherein said second project ends a month or more after said first project ends.

17. The method of claim 15, wherein said supplier and purchaser are members of a single organization.

18. The method of claim 17, wherein said members are profit centers.
